(19) United States
(12) Patent Application Publication
(10) Pub. No.: US 2016/0260280 A1
(43) Pub. Date: Sep. 8, 2016

(54) Information Prompting Method and Device for Prompting Ticket Drawing Result

(71) Applicant: TENCENT TECHNOLOGY (SHENZHEN) COMPANY LIMITED, Shenzhen (CN)

(72) Inventor: Wenbin He, Shenzhen (CN)

(21) Appl. No.: 15/156,380

(22) Filed: May 17, 2016

Related U.S. Application Data
(63) Continuation of application No. PCT/CN2014/090682, filed on Nov. 10, 2014.

(30) Foreign Application Priority Data
Nov. 27, 2013 (CN) 201310617057.1

(51) Int. Cl. G07F 17/32; G06Q 50/34

(52) U.S. Cl. CPC G07F 17/329; G06Q 50/34; G07F 17/3244

(57) ABSTRACT

The provided is an information prompting method and device for prompting a ticket drawing result. The method includes: scanning a graphic code of a ticket to obtain property information associated with the graphic code, the property information comprising a predetermined drawing time thread value of the ticket; adding a drawing prompt event corresponding to the predetermined drawing time thread value to a preset event list once a real-time current time value does not exceed the drawing time thread value; upon a condition that the drawing time thread value is up, triggering the drawing prompt event; according to triggering of the drawing prompt event, searching for check information associated with the property information from a ticket management server; generating result matching information of the ticket according to the check information, the result matching information comprising the drawing result; and prompting the result matching information in a sensible form.

This application is a continuation of International Application No. PCT/CN2014/090682, filed on Nov. 10, 2014. This application claims the benefit of priority from Chinese Patent Application, No. 201310617057.1, entitled “Information Processing Method and Device” and filed on Nov. 27, 2013, the entire content of which is hereby incorporated by reference.

### TECHNICAL FIELD

The present disclosure relates to computer technologies, and more particularly to an information prompting method and device for prompting a ticket drawing result.

### BACKGROUND

Ticket industry has been developed to meet the requirements of social groups and promote the growth of social economy. For example, the launch of lottery ticket may improve the development of public welfare undertakings such as social welfare, public health, education and culture. By the launch of lottery ticket, social idle funds may be assigned again legally and equitably.

Tickets usually have a period of validity. Once a real-time current time value exceeds the drawing time thread value of a ticket, the ticket may become invalid because check information (for example, a winning number) is unable to be obtained in time. If a user intends to check a lottery result, the user needs to initiatively obtain the check information through a television, a computer or a mobile phone, and compares the check information with information about the ticket, thereby decreasing the efficiency of checking the lottery result and further influencing the real-time performance of a device.

### SUMMARY

Embodiments of the present disclosure provide an information prompting method and device for prompting a ticket drawing result, by which check information associated with a ticket may be obtained initiatively, thereby improving the real-time performance of a device.

An embodiment of the present disclosure provides a processor-implemented information prompting method for prompting a ticket drawing result, which includes:

scanning a graphic code of a ticket to obtain property information associated with the graphic code, the property information comprising a predetermined drawing time thread value of the ticket;

adding a drawing prompt event corresponding to the predetermined drawing time thread value to a preset event list once a real-time current time value does not exceed the drawing time thread value;

upon a condition that the drawing time thread value is up, triggering the drawing prompt event;

according to triggering of the drawing prompt event, searching for check information associated with the property information from a ticket management server;

generating result matching information of the ticket according to the check information, the result matching information comprising the drawing result; and

prompting the result matching information in a sensible form.

An embodiment of the present disclosure provides an information prompting device for prompting a ticket drawing result, which includes:

a scanning and obtaining module, configured to scan a graphic code of a ticket to obtain property information associated with the graphic code, the property information comprising a predetermined drawing time thread value of the ticket;

an event adding module, configured to add a drawing prompt event corresponding to the predetermined drawing time thread value to a preset event list once a real-time current time value does not exceed the drawing time thread value;

an event triggering module, configured to trigger the drawing prompt event upon a condition that the drawing time thread value is up;

an information obtaining module, configured to, according to triggering of the drawing prompt event, search for check information associated with the property information from a ticket management server; and

a generating and prompting module, configured to generate result matching information of the ticket according to the check information, the result matching information comprising the drawing result; and prompt the result matching information in a sensible form.

An embodiment of the present disclosure also provides a computer readable storage medium, including computer program codes for executing the steps in the above mentioned method.

In the embodiments of the present disclosure, the graphic code may be set on the ticket. The device may obtain the property information including the type name and issue number of the ticket through scanning the graphic code, and obtain the check information associated with the property information. The device generates the result matching information of the ticket according to the check information, and prompts the result matching information in time. As can be seen, the device may initiatively obtain the check information associated with the property information, generate the result matching information of the ticket according to the check information in real time and prompt the result matching information in time, thereby effectively improving the efficiency of checking a lottery result and further improving the real-time performance of the device.

### BRIEF DESCRIPTION OF DRAWINGS

In order to describe the solution provided by the embodiments of the present disclosure clearly, the accompanying drawings referred to in the embodiments are illustrated briefly hereinafter. Obviously, these accompanying drawings are some examples of the present disclosure, and according to these accompanying drawings, those skilled in the art can obtain other accompanying drawings without creative labor.

FIG. 1 is a flowchart illustrating an information prompting method for prompting a ticket drawing result according to an embodiment of the present disclosure.

FIG. 2 is a flowchart illustrating an information prompting method for prompting a ticket drawing result according to another embodiment of the present disclosure.

FIG. 3 is a flowchart illustrating an information prompting method for prompting a ticket drawing result according to another embodiment of the present disclosure.

FIG. 4 is a flowchart illustrating an information prompting method for prompting a ticket drawing result according to another embodiment of the present disclosure.

FIG. 5 is a diagram illustrating an example for implementing an information prompting method according to an embodiment of the present disclosure.

FIG. 6 is a diagram illustrating an example for implementing an information prompting method according to another embodiment of the present disclosure.

FIG. 7 is a diagram illustrating the structure of an information prompting device for prompting a ticket drawing result according to an embodiment of the present disclosure.

FIG. 8 is a diagram illustrating the structure of an information prompting device for prompting a ticket drawing result according to another embodiment of the present disclosure.

FIG. 9 is a diagram illustrating the structure of an information prompting device for prompting a ticket drawing result according to another embodiment of the present disclosure.

FIG. 10 is a diagram illustrating the structure of an information prompting device for prompting a ticket drawing result according to another embodiment of the present disclosure.

FIG. 11 is a diagram illustrating the structure of an information prompting system for prompting a ticket drawing result according to an embodiment of the present disclosure.

### DETAILED DESCRIPTION

The embodiments of the present disclosure will be illustrated hereinafter with reference to the accompanying drawings. Obviously, the described embodiments are only partial embodiments of the present disclosure, but are not all embodiments. According to the embodiments of the present disclosure, those skilled in the art can obtain other embodiments without creative labor, which belong to the protection scope of the present disclosure.

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to.

In the embodiments of the present disclosure, the information prompting device may be a computer, a tablet computer, a smart mobile phone, a laptop, a palm computer, a Mobile Internet Device (MID) or a PAD.

The information prompting method provided by the embodiments of the present disclosure may be applied to a lottery cashing scenario. For example, through setting a graphic code on a lottery ticket, a user may scan the graphic code with an information prompting device, and obtain property information including the type name and issue number of the lottery ticket. The device obtains check information associated with the property information, and generates result matching information of the lottery ticket according to the check information. The device may determine according to the result matching information whether the lottery ticket wins. The information prompting method may also be applied to a raffle cashing scenario in a mall. For example, through setting a graphic code in a raffle ticket, a user may scan the graphic code with an information prompting device, and obtain property information including the type name and issue number of the raffle ticket. The device obtains check information associated with the property information, and generates result matching information of the raffle ticket according to the check information. The device may determine according to the result matching information whether the raffle ticket wins. In the embodiments of the present disclosure, through setting the graphic code on a ticket, the information prompting device may scan the graphic code and obtain the property information of the ticket. The device may further obtain the check information associated with the property information, and generate the result matching information of the ticket according to the check information. As can be seen, the device may initiatively obtain the check information associated with the ticket, and generate the result matching information of the ticket in real time, thereby improving the efficiency of checking a lottery result and further improving the real-time performance of the device.

The graphic code described in the embodiments of the present disclosure may be a bar code, a two-dimensional code or a three-dimensional code. The property information may include the type name and issue number of the ticket, and may further include a ticket identification and drawing time thread value of the ticket. The check information may be information associated with the property information including the type name and issue number of the ticket, for example, include the type name, issue number, drawing time thread value and winning identification of the ticket. The result matching information may include a winning prompt and a cashing deadline. The ticket identification may be a number or a graphic for cashing. The winning identification of the ticket may be a winning number or a winning graphic that correspond to the type name and issue number of the ticket.

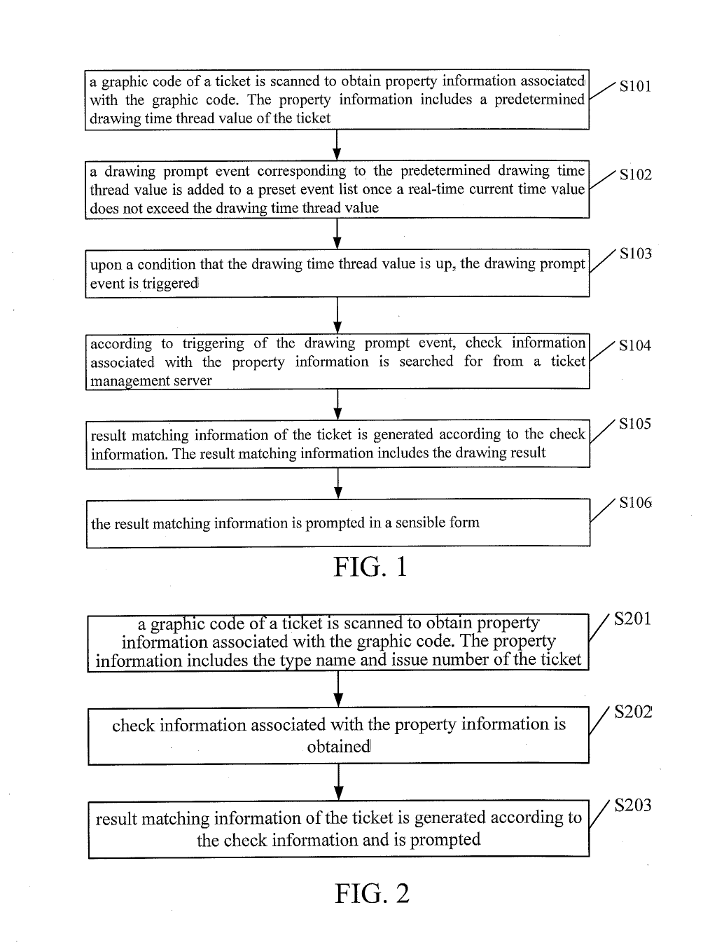

The information prompting method provided by the embodiments of the present disclosure will be described hereinafter with reference to FIGS. 1-4.

FIG. 1 is a flowchart illustrating an information prompting method for prompting a ticket drawing result according to an embodiment of the present disclosure. As shown in FIG. 1, the method includes following blocks.

At block 101, a graphic code of a ticket is scanned to obtain property information associated with the graphic code. The property information includes a predetermined drawing time thread value of the ticket.

At block 102, a drawing prompt event corresponding to the predetermined drawing time thread value is added to a preset event list once a real-time current time value does not exceed the drawing time thread value.

At block 103, upon a condition that the drawing time thread value is up, the drawing prompt event is triggered.

At block 104, according to triggering of the drawing prompt event, check information associated with the property information is searched for from a ticket management server.

At block 105, result matching information of the ticket is generated according to the check information. The result matching information includes the drawing result.

At block 106, the result matching information is prompted in a sensible form.

In this embodiment, the property information further includes a type name and an issue number of the ticket, and the process of searching for the check information associated with the property information from the ticket management server includes: searching for the issue number of the ticket recorded in the ticket management server according to the type name of the ticket, and obtaining the check information associated with the issue number of the ticket from the ticket management server.

In this embodiment, the property information further includes a ticket identification of the ticket, and the check information includes a winning identification. The process of generating the result matching information of the ticket according to the check information includes: matching the ticket identification of the ticket with the winning identification, and generating the result matching information of the ticket according to a matching result, and the result matching information further comprises a winning prompt.

Before searching for the check information associated with the property information from the ticket management server, the method further includes: comparing the real-time current time value with the predetermined drawing time thread value; upon determining that the real-time current time value exceeds the predetermined drawing time thread value, obtaining the check information associated with the property information; and upon determining that the real-time current time value does not exceed the predetermined drawing time thread value, obtaining the check information associated with the property information when the predetermined drawing time thread value is up.

FIG. 2 is a flowchart illustrating an information prompting method for prompting a ticket drawing result according to another embodiment of the present disclosure. As shown in FIG. 2, the method includes following blocks.

At block S201, a graphic code of a ticket is scanned to obtain property information associated with the graphic code. The property information includes the type name and issue number of the ticket.

When the ticket is printed, the graphic code of the ticket may be printed together with the ticket. A user may scan the graphic code through an information prompting device. A camera and a scanning application of the device may implement the function of scanning the graphic code together. For example, the scanning application may be a scanning application of instant messaging software in the device. The device may obtain the property information including the type name and issue number of the ticket through scanning the graphic code of the ticket. For example, the type name of the ticket may be “XX ticket”, and the issue number of the ticket may be “the 21^{th} issue”.

At block S202, check information associated with the property information is obtained.

The device obtains the check information associated with the property information. For example, the device may obtain the check information associated with the issue number of the ticket from a ticket management server according to the type name of the ticket.

At block S203, result matching information of the ticket is generated according to the check information and is prompted.

The property information may further include a ticket identification of the ticket. A process of generating the result matching information of the ticket according to the check information by the device may include matching the ticket identification with a winning identification, and generating the result matching information of the ticket according to a matching result. The device prompts the result matching information.

In the embodiment of the present disclosure, the graphic code may be set on the ticket. The device may obtain the property information including the type name and issue number of the ticket through scanning the graphic code, and obtain the check information associated with the property information. The device generates the result matching information of the ticket according to the check information, and prompts the result matching information in time. As can be seen, the device may initiatively obtain the check information associated with the property information, generate the result matching information of the ticket according to the check information in real time and prompt the result matching information in time. Accordingly, a user may learn according to the result matching information whether the ticket wins, thereby improving user experiences and the efficiency of checking a lottery result and further improving the real-time performance of the device.

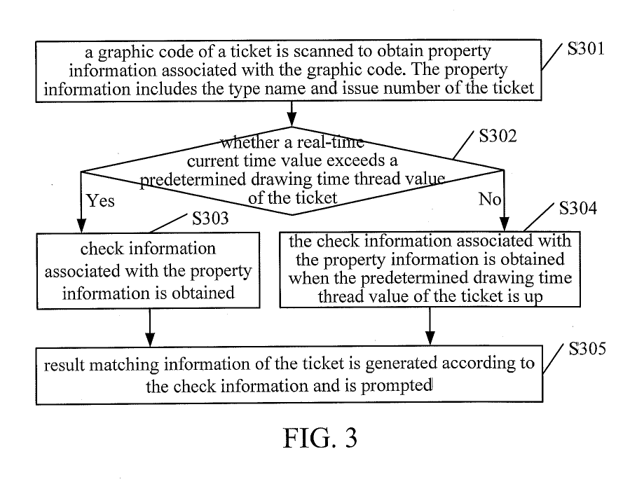

FIG. 3 is a flowchart illustrating an information prompting method for prompting a ticket drawing result according to another embodiment of the present disclosure. As shown in FIG. 3, the method includes following blocks.

At block S301, a graphic code of a ticket is scanned to obtain property information associated with the graphic code. The property information includes the type name and issue number of the ticket.

When the ticket is printed, the graphic code of the ticket may be printed together with the ticket. A user may scan the graphic code through an information prompting device. A camera and a scanning application of the device may implement the function of scanning the graphic code together. For example, the scanning application may be a scanning application of instant messaging software in the device. The device may obtain the property information including the type name and issue number of the ticket through scanning the graphic code of the ticket. For example, the type name of the ticket may be “XX ticket”, and the issue number of the ticket may be “the 21^{th} issue”.

At block S302, it is determined whether a real-time current time value exceeds a predetermined drawing time thread value of the ticket.

In an example, the property information further includes the predetermined drawing time thread value of the ticket. The information prompting device may determine whether the real-time current time value exceeds the predetermined drawing time thread value of the ticket. When it is determined that the real-time current time value exceeds the predetermined drawing time thread value of the ticket, block S303 is performed. When it is determined that the real-time current time value does not exceed the predetermined drawing time thread value of the ticket, block S304 is performed.

At block S303, check information associated with the property information is obtained.

When it is determined that the real-time current time value exceeds the predetermined drawing time thread value of the ticket, the device directly obtains the check information associated with the property information. For example, the device may obtain the check information associated with the issue number of the ticket from a ticket management server according to the type name of the ticket.

At block S304, the check information associated with the property information is obtained when the predetermined drawing time thread value of the ticket is up.

When it is determined that the real-time current time value does not exceed the predetermined drawing time thread value of the ticket, the device may perform time monitoring. When the predetermined drawing time thread value of the ticket is up, the device may directly obtain the check information associated with the property information. For example, the device may obtain the check information associated with the issue number of the ticket from the ticket management server according to the type name of the ticket.

At block S305, result matching information of the ticket is generated according to the check information and is prompted.

The property information may further include a ticket identification of the ticket. A process of generating the result matching information of the ticket according to the check information by the device may include matching the ticket identification of the ticket with a winning identification, and generating the result matching information of the ticket according to a matching result. The device prompts the result matching information.

In the embodiment of the present disclosure, the graphic code may be set on the ticket. The device may obtain the property information including the type name and issue number of the ticket through scanning the graphic code, and obtain the check information associated with the property information. The device generates the result matching information of the ticket according to the check information, and prompts the result matching information in time. Before obtaining the check information, the device may compares the real-time current time value with the predetermined drawing time thread value. When the real-time current time value exceeds the predetermined drawing time thread value, the device may initiatively obtain the check information associated with the property information of the ticket, generate the result matching information of the ticket according to the check information in real time and prompt the result matching information in time. Accordingly, a user may learn according to the result matching information whether the ticket wins, thereby improving user experiences and the efficiency of checking a lottery result and further improving the real-time performance of the device.

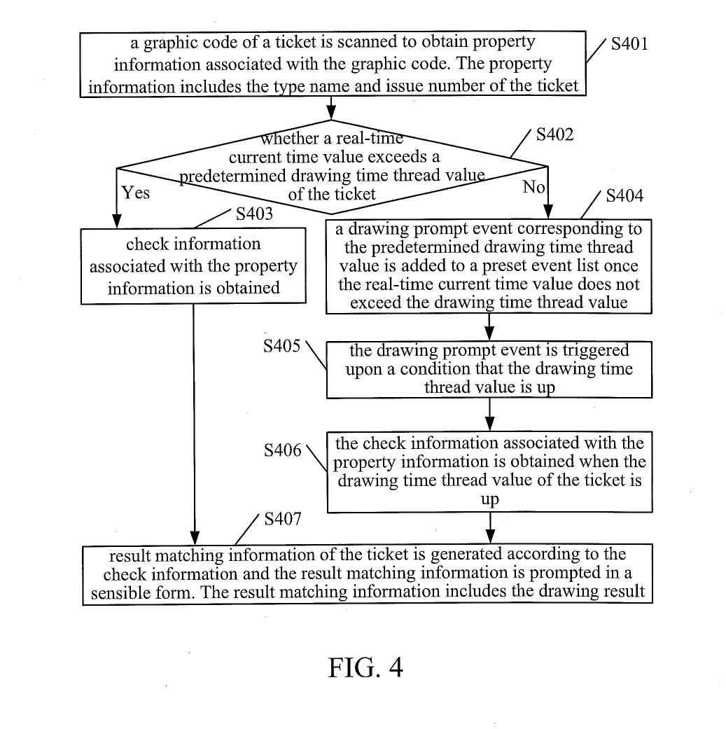

FIG. 4 is a flowchart illustrating an information prompting method for prompting a ticket drawing result according to another embodiment of the present disclosure. As shown in FIG. 4, the method includes following blocks.

At block S401, a graphic code of a ticket is scanned to obtain property information associated with the graphic code. The property information includes the type name and issue number of the ticket.

When the ticket is printed, the graphic code of the ticket may be printed together with the ticket. A user may scan the graphic code through an information prompting device. A camera and a scanning application of the device may implement the function of scanning the graphic code together. For example, the scanning application may be a scanning application of instant messaging software in the device. The device may obtain the property information including the type name and issue number of the ticket through scanning the graphic code of the ticket. For example, the type name of the ticket may be “XX ticket”, and the issue number of the ticket may be “the 21^{th} issue”.

At block S402, it is determined whether a real-time current time value exceeds a predetermined drawing time thread value of the ticket.

In an example, the property information further includes the predetermined drawing time thread value of the ticket. The information prompting device may determine whether the real-time current time value exceeds the predetermined drawing time thread value of the ticket. When it is determined that the real-time current time value exceeds the predetermined drawing time thread value of the ticket, block S403 is performed. When it is determined that the real-time current time value does not exceed the predetermined drawing time thread value of the ticket, block S404 is performed.

At block S403, check information associated with the property information is obtained.

When it is determined that the real-time current time value exceeds the predetermined drawing time thread value of the ticket, the device directly obtains the check information associated with the property information. For example, the device may obtain the check information associated with the issue number of the ticket from a ticket management server according to the type name of the ticket.

At block 404, a drawing prompt event corresponding to the predetermined drawing time thread value is added to a preset event list once the real-time current time value does not exceed the drawing time thread value.

When it is determined that the real-time current time value does not exceed the drawing time thread value, the device may add the drawing prompt event corresponding to the predetermined drawing time thread value to the event list.

At block S405, the drawing prompt event is triggered upon a condition that the drawing time thread value is up.

When the drawing time thread value of the ticket is up, the device may trigger the added drawing prompt event. For example, a first drawing prompt event may include outputting an alarm through a speaker of the device, and a second drawing prompt event may include outputting prompt information through a display of the device. In a following example, the second drawing prompt event is adopted. In the example, when the drawing time thread value of the ticket is up, the device may obtain the winning identification associated with the property information of the ticket from the ticket management server, generate the prompt information according to the winning identification, and output the prompt information to the display of the device.

At block S406, the check information associated with the property information is obtained when the drawing time thread value of the ticket is up. In this embodiment, according to the triggering of the drawing prompt event, the check information associated with the property information is searched for from a ticket management server.

When the drawing time thread value of the ticket is up, the device may directly obtain the check information associated with the property information. For example, the device may obtain the check information associated with the issue number of the ticket from the ticket management server according to the type name of the ticket.

At block S407, result matching information of the ticket is generated according to the check information and the result matching information is prompted in a sensible form. The result matching information includes the drawing result.

The property information may further include a ticket identification of the ticket. A process of generating the result matching information of the ticket according to the check information by the device may include matching the ticket identification of the ticket with a winning identification, and generating the result matching information of the ticket according to a matching result. The device prompts the result matching information.

Blocks S405 and S406 in the embodiment of the present disclosure may be performed at the same time. That is, when the drawing time thread value of the ticket is up, the device may perform blocks S405 and S406 at the same time.

In the embodiment of the present disclosure, the graphic code may be set on the ticket. The device may obtain the property information including the type name and issue number of the ticket through scanning the graphic code, and obtain the check information associated with the property information. The device generates the result matching information of the ticket according to the check information, and prompts the result matching information in time. Before obtaining the check information, the device may compares the real-time current time value with the predetermined drawing time thread value. When the real-time current time value does not exceed the predetermined drawing time thread value, the device may add the drawing prompt event, thereby providing a reminding function. When the predetermined drawing time thread value is up, the device triggers the drawing prompt event to remind the user, initiatively obtains the check information associated with the property information of the ticket, generates the result matching information of the ticket according to the check information in real time and prompts the result matching information in time. Accordingly, a user may learn according to the result matching information whether the ticket wins, thereby improving user experiences and the efficiency of checking a lottery result and further improving the real-time performance of the device.

The information prompting method will be described hereinafter with reference to an example.

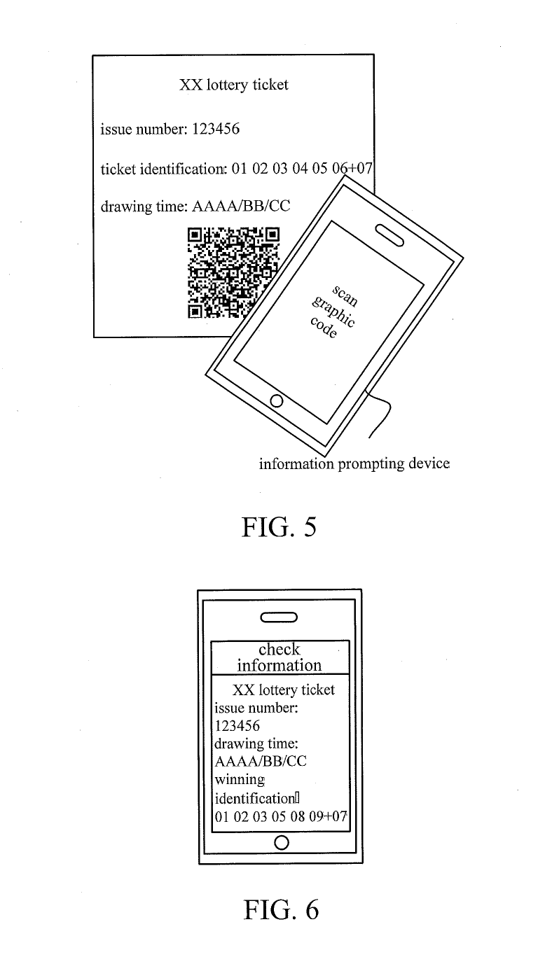

FIG. 5 is a diagram illustrating an example for implementing an information prompting method according to an embodiment of the present disclosure. As shown in FIG. 5, the type name of a ticket is “XX lottery ticket”, the issue number of the ticket is “123456”, the ticket identification of the ticket is “01 02 03 04 05 06+07”, and a predetermined drawing time thread value is “AAAA/BB/CC”.

A graphic code may be set on the XX lottery ticket. A user may scan the graphic code through an information prompting device, and obtain property information including the type name, issue number, ticket identification and predetermined drawing time thread value of the ticket. The device may obtain check information associated with the issue number of the ticket from a ticket management server according to the type name of the ticket. FIG. 6 is a diagram illustrating an example for implementing an information prompting method according to another embodiment of the present disclosure. Referring to FIG. 6, the check information obtained by the device may include following information, for example, the type name of the ticket is “XX lottery ticket”, the issue number of the ticket is “123456”, the predetermined drawing time thread value of the ticket is “AAAA/BB/CC” and the ticket identification of the ticket is “01 02 03 05 08 09+07”. The device matches the ticket identification with a winning identification contained in the check information, generates result matching information of the ticket according to a matching result, and prompts the result matching information.

In the embodiment of the present disclosure, the graphic code may be set on the ticket. The device may obtain the property information including the type name and issue number of the ticket through scanning the graphic code, and obtain the check information associated with the property information. The device generates the result matching information of the ticket according to the check information, and prompts the result matching information in time. As can be seen, the device may initiatively obtain the check information associated with the property information, generate the result matching information of the ticket according to the check information in real time and prompt the result matching information in time. Accordingly, a user may learn according to the result matching information whether the ticket wins, thereby improving user experiences and the efficiency of checking a lottery result and further improving the real-time performance of the device.

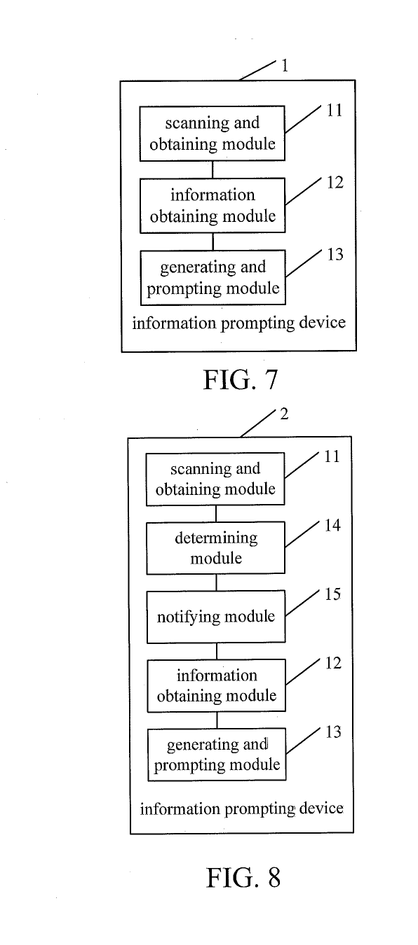

Information prompting devices provided by the embodiments of the present disclosure will be described hereinafter with reference to FIGS. 7-9. The information prompting devices shown in FIGS. 7-9 may perform the method described in the embodiments shown in FIGS. 1-4. In order to be convenient for description, parts related to the embodiments of the present disclosure are shown, and those undisclosed details may refer to the embodiments shown in FIGS. 1-4.

FIG. 7 is a diagram illustrating the structure of an information prompting device for prompting a ticket drawing result according to an embodiment of the present disclosure. As shown in FIG. 7, an information prompting device 1 includes a scanning and obtaining module 11, an information obtaining module 12 and a generating and prompting module 13.

The scanning and obtaining module 11 may scan a graphic code of a ticket to obtain property information associated with the graphic code. The property information includes the type name and issue number of the ticket.

When the ticket is printed, the graphic code of the ticket may be printed together with the ticket. A user may scan the graphic code through the information prompting device 1. A camera and a scanning application of the information prompting device 1 may implement the function of scanning the graphic code together. For example, the scanning application may be a scanning application of instant messaging software in the information prompting device 1. The scanning and obtaining module 11 may obtain the property information including the type name and issue number of the ticket through scanning the graphic code of the ticket. For example, the type name of the ticket may be “XX ticket”, and the issue number of the ticket may be “the 21^{th} issue”.

The information obtaining module 12 may obtain check information associated with the property information.

The information obtaining module 12 may obtain the check information associated with the property information. For example, the information obtaining module 12 may obtain the check information associated with the issue number of the ticket from a ticket management server according to the type name of the ticket.

The generating and prompting module 13 may generate result matching information of the ticket according to the check information, and prompt the result matching information.

The property information further includes a ticket identification of the ticket. A process of generating the result matching information of the ticket according to the check information by the generating and prompting module 13 may include matching the ticket identification with a winning identification, and generating the result matching information of the ticket according to a matching result. The generating and prompting module 13 prompts the result matching information.

In the embodiment of the present disclosure, the graphic code may be set on the ticket. The device may obtain the property information including the type name and issue number of the ticket through scanning the graphic code, and obtain the check information associated with the property information. The device generates the result matching information of the ticket according to the check information, and prompts the result matching information in time. As can be seen, the device may initiatively obtain the check information associated with the property information, generate the result matching information of the ticket according to the check information in real time and prompt the result matching information in time. Accordingly, a user may learn according to the result matching information whether the ticket wins, thereby improving user experiences and the efficiency of checking a lottery result and further improving the real-time performance of the device.

FIG. 8 is a diagram illustrating the structure of an information prompting device for prompting a ticket drawing result according to another embodiment of the present disclosure. As shown in FIG. 8, an information prompting device 2 includes a scanning and obtaining module 11, an information obtaining module 12, a generating and prompting module 13, a determining module 14 and a notifying module 15. The functions of the scanning and obtaining module 11, the information obtaining module 12 and the generating and prompting module 13 may refer to the description in the embodiment shown in FIG. 7.

The determining module 14 may determine whether a real-time current time value exceeds a predetermined drawing time thread value of the ticket.

In an example, the property information further includes the predetermined drawing time thread value of the ticket. The determining module 14 may determine whether the real-time current time value exceeds the predetermined drawing time thread value of the ticket, and send a determining result to the notifying module 15.

When the determining module 14 determines that the real-time current time value exceeds the predetermined drawing time thread value of the ticket, the notifying module 15 may notify the information obtaining module 12 to obtain the check information associated with the property information.

When the determining module 14 determines that the real-time current time value does not exceed the predetermined drawing time thread value of the ticket, and when the predetermined drawing time thread value of the ticket is up, the notifying module 15 may notify the information obtaining module 12 to obtain the check information associated with the property information.

In the embodiment of the present disclosure, the graphic code may be set on the ticket. The device may obtain the property information including the type name and issue number of the ticket through scanning the graphic code, and obtain the check information associated with the property information. The device generates the result matching information of the ticket according to the check information, and prompts the result matching information in time. Before obtaining the check information, the device may compares the real-time current time value with the predetermined drawing time thread value of the ticket. When the real-time current time value exceeds the predetermined drawing time thread value of the ticket, the device may initiatively obtain the check information associated with the property information of the ticket, generate the result matching information of the ticket according to the check information in real time and prompt the result matching information in time. Accordingly, a user may learn according to the result matching information whether the ticket wins, thereby improving user experiences and the efficiency of checking a lottery result and further improving the real-time performance of the device.

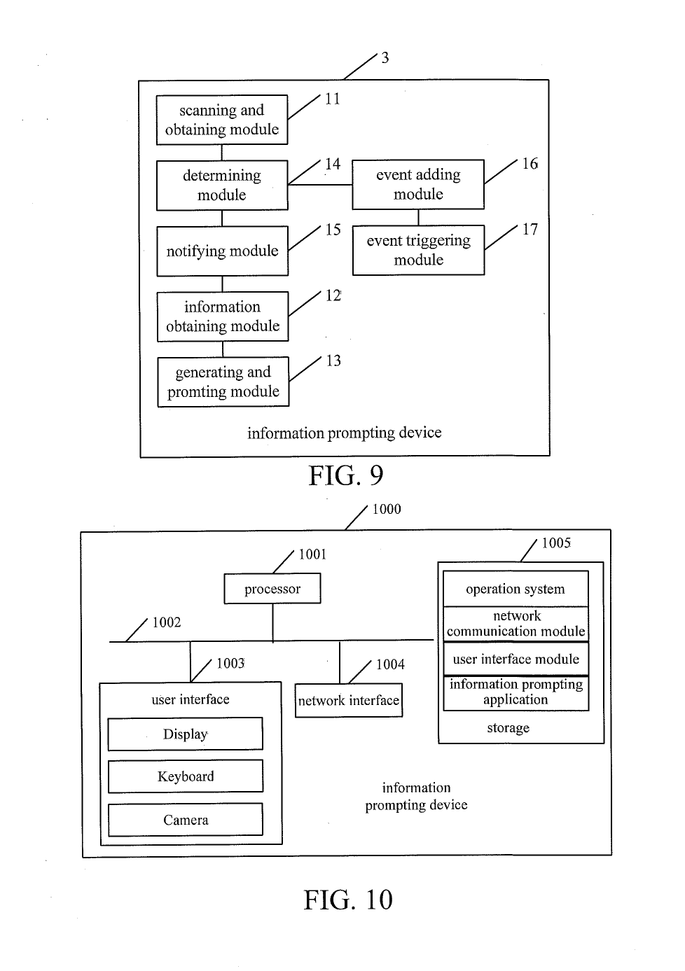

FIG. 9 is a diagram illustrating the structure of an information prompting device for prompting a ticket drawing result according to another embodiment of the present disclosure. As shown in FIG. 9, an information prompting device 3 includes a scanning and obtaining module 11, an information obtaining module 12, a generating and prompting module 13, a determining module 14, a notifying module 15, an event adding module 16 and an event triggering module 17. The functions of the scanning and obtaining module 11, the information obtaining module 12 and the generating and prompting module 13 may refer to the description in the embodiment shown in FIG. 7, and the functions of the determining module 14 and the notifying module 15 may refer to the description in the embodiment shown in FIG. 8.

The event adding module 16 may add a drawing prompt event corresponding to the predetermined drawing time thread value to a preset event list when the determining module 14 determines that the real-time current time value does not exceed the drawing time thread value.

The event triggering module 17 may trigger the drawing prompt event upon a condition that the drawing time thread value is up.

According to triggering of the drawing prompt event, the information obtaining module 12 searches for the check information associated with the property information from a ticket management server.

When the drawing time thread value is up, the event triggering module 17 may trigger the added drawing prompt event. For example, a first drawing prompt event may include outputting an alarm through a speaker of the information prompting device 3, and a second drawing prompt event may include outputting prompt information through a display of the information prompting device 3. In a following example, the second drawing prompt event is adopted. In the example, when the drawing time thread value is up, the information obtaining module 12 may obtain the winning identification associated with the property information of the ticket from a ticket management server, and the event triggering module 17 generates the prompt information according to the winning identification, and outputs the prompt information to the display of the device.

In the embodiment of the present disclosure, the graphic code may be set on the ticket. The device may obtain the property information including the type name and issue number of the ticket through scanning the graphic code, and obtain the check information associated with the property information. The device generates the result matching information of the ticket according to the check information, and prompts the result matching information in time. Before obtaining the check information, the device may compares the real-time current time value with the drawing time thread value. When the real-time current time value does not exceed the drawing time thread value, the device may add the drawing prompt event, thereby providing a reminding function. When the the drawing time thread value is up, the device triggers the drawing prompt event to remind the user, initiatively obtains the check information associated with the property information of the ticket, generates the result matching information of the ticket according to the check information in real time and prompts the result matching information in time. Accordingly, a user may learn according to the result matching information whether the ticket wins, thereby improving user experiences and the efficiency of checking a lottery result and further improving the real-time performance of the device.

FIG. 10 is a diagram illustrating the structure of an information prompting device for prompting a ticket drawing result according to another embodiment of the present disclosure. As shown in FIG. 10, an information prompting device 1000 includes at least one processor 1001, for example, CPU, at least one network interface 1004, a user interface 1003, a storage 1005 and at least one communication bus 1002. The communication bus 1002 may be used to implement the connection and communication among the above components. The user interface 1003 may include a display, a keyboard and a camera. The user interface 1003 may further include a standard wired interface and a radio interface. The network interface 1004 may include a standard wired interface and a radio interface (for example, a WI-FI interface). The storage 1005 may be a high-speed RAM or a non-volatile memory, for example, at least one disk storage. The storage 1005 may also be a storage apparatus far away from the processor 1001. As shown in FIG. 10, the storage 1005 used as a computer storage medium may include an operation system, a network communication module, a user interface module and an information prompting application.

In the information prompting device 1000 shown in FIG. 10, the network interface 1004 may be used for data communication between the information prompting device 1000 and a ticket management server. The user interface 1003 may be used to provide an input interface for a user and obtain data input by the user. The processor 1001 may be used to invoke an information prompting application stored in the storage 1005, and perform following processes:

scanning a graphic code of a ticket to obtain property information associated with the graphic code, wherein the property information includes the type name and issue number of the ticket;

obtaining check information associated with the property information; and

generating result matching information of the ticket according to the check information, and prompting the result matching information.

In an embodiment, a process of obtaining the check information associated with the property information by the processor 1001 includes:

obtaining the check information associated with the issue number of the ticket from a ticket management server according to the type name of the ticket.

In an embodiment, the property information further includes a ticket identification of the ticket, and the check information includes a winning identification. A process of generating the result matching information of the ticket according to the check information by the processor 1001 includes:

matching the ticket identification of the ticket with the winning identification, and generating the result matching information of the ticket according to a matching result. The result matching information includes a winning prompt.

In an embodiment, the property information further includes a predetermined drawing time thread value of the ticket. Before obtaining the check information associated with the property information, the processor 1001 performs:

determining whether the real-time current time value exceeds the drawing time thread value;

when determining that the real-time current time value exceeds the drawing time thread value, obtaining the check information associated with the property information; and

when determining that the real-time current time value does not exceed the drawing time thread value, obtaining the check information associated with the property information when the drawing time thread value is up.

In an embodiment, when determining that the real-time current time value does not exceed the drawing time thread value and before the drawing time thread value is up, the processor 1001 performs:

adding a drawing prompt event corresponding to the predetermined drawing time thread value to a preset event list; and

triggering the drawing prompt event when the drawing time thread value is up.

In an embodiment, the graphic code is a bar code, a two-dimensional code or a three-dimensional code.

In the embodiment of the present disclosure, the graphic code may be set on the ticket. The device may obtain the property information including the type name and issue number of the ticket through scanning the graphic code, and obtain the check information associated with the property information. The device generates the result matching information of the ticket according to the check information, and prompts the result matching information in time. Before obtaining the check information, the device may compares the real-time current time value with the drawing time thread value. When the real-time current time value does not exceed the drawing time thread value, the device may add the drawing prompt event, thereby providing a reminding function. When the drawing time thread value is up, the device triggers the drawing prompt event to remind the user, initiatively obtains the check information associated with the property information of the ticket, generates the result matching information of the ticket according to the check information in real time and prompts the result matching information in time. Accordingly, a user may learn according to the result matching information whether the ticket wins, thereby improving user experiences and the efficiency of checking a lottery result and further improving the real-time performance of the device.

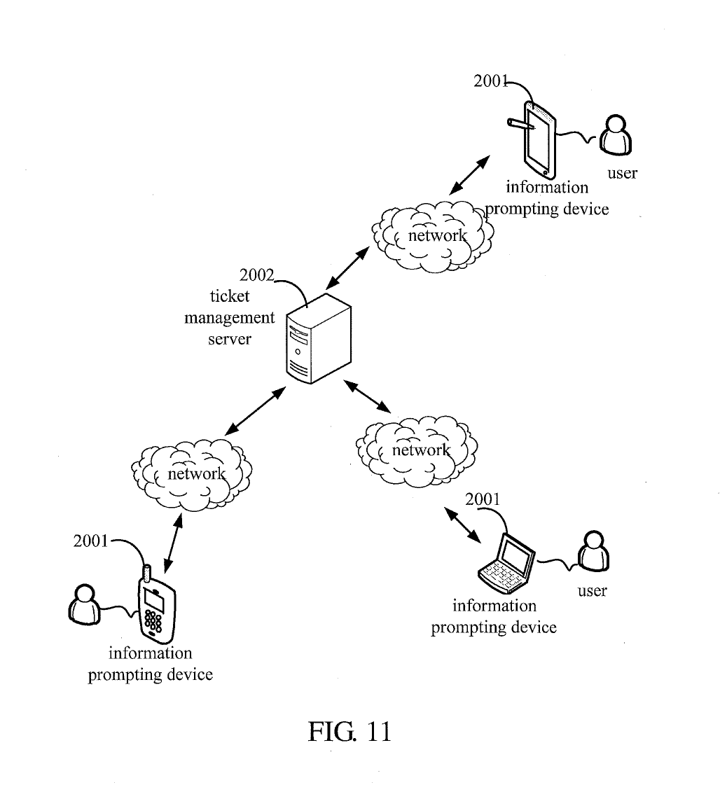

FIG. 11 is a diagram illustrating the structure of an information prompting system for prompting a ticket drawing result according to an embodiment of the present disclosure. As shown in FIG. 11, the information prompting system may include an information prompting device 2001 and a ticket management server 2002. The information prompting device 2001 may be connected to the ticket management server 2002 through a network. The information prompting device 2001 may be any one of information prompting devices shown in FIGS. 7-9.

The information prompting device 2001 may scan a graphic code of a ticket to obtain property information associated with the graphic code. The property information includes the type name and issue number of the ticket.

When receiving a check information request from the information prompting device 2001, the ticket management server 2002 sends to the information prompting device 2001 check information associated with the issue number of the ticket according to the type name of the ticket.

The information prompting device 2001 may obtain the check information associated with the property information.

The information prompting device 2001 may generate result matching information of the ticket according to the check information, and prompt the result matching information.

In an embodiment, the property information further includes a ticket identification of the ticket, and the check information includes a winning identification. A process of generating the result matching information of the ticket according to the check information by the information prompting device 2001 includes:

matching the ticket identification of the ticket with the winning identification, and generating the result matching information of the ticket according to a matching result. The result matching information includes a winning prompt.

In an embodiment, the property information further includes a predetermined drawing time thread value of the ticket.

The information prompting device 2001 may further determine whether a real-time current time value exceeds the drawing time thread value.

When determining that the real-time current time value exceeds the drawing time thread value, the information prompting device 2001 obtains the check information associated with the property information.

When determining that the real-time current time value does not exceed the drawing time thread value, the information prompting device 2001 obtains the check information associated with the property information when the drawing time thread value is up.

In an embodiment, when determining that the real-time current time value does not exceed the drawing time thread value and before the drawing time thread value is up, the information prompting device 2001 may further add a drawing prompt event corresponding to the predetermined drawing time thread value to a preset event list, and trigger the drawing prompt event when the drawing time thread value is up.

In an embodiment, the graphic code may be a bar code, a two-dimensional code or three-dimensional code.

In the embodiment of the present disclosure, the graphic code may be set on the ticket. The device may obtain the property information including the type name and issue number of the ticket through scanning the graphic code, and obtain the check information associated with the property information from the ticket management server. The device generates the result matching information of the ticket according to the check information, and prompts the result matching information in time. Before obtaining the check information, the device may compare the real-time current time value with the drawing time thread value. When the real-time current time value does not exceed the drawing time thread value, the device may add the drawing prompt event, thereby providing a reminding function. When the drawing time thread value is up, the device triggers the drawing prompt event to remind the user, initiatively obtains the check information associated with the property information of the ticket, generates the result matching information of the ticket according to the check information in real time and prompts the result matching information in time. Accordingly, a user may learn according to the result matching information whether the ticket wins, thereby improving user experiences and the efficiency of checking a lottery result and further improving the real-time performance of the device.

Those skilled in the art can understand that all or part of steps in the method provided by the embodiments of the present disclosure can be implemented by instructing related hardware by a program, the program may be stored in a readable memory of a computer, and above method steps are included when the program is operated. The memory includes a Read-Only Memory (ROM)/Random Access Memory (RAM), a disk, a Compact Disc (CD) and so on.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A processor-implemented information prompting method for prompting a ticket drawing result, comprising:
scanning a graphic code of a ticket to obtain property information associated with the graphic code, the property information comprising a predetermined drawing time thread value of the ticket;
adding a drawing prompt event corresponding to the predetermined drawing time thread value to a preset event list once a real-time current time value does not exceed the drawing time thread value;
upon a condition that the drawing time thread value is up, triggering the drawing prompt event;
according to triggering of the drawing prompt event, searching for check information associated with the property information from a ticket management server;
generating result matching information of the ticket according to the check information, the result matching information comprising the drawing result; and
prompting the result matching information in a sensible form.

2. The method of claim 1, wherein the property information further comprises a type name and an issue number of the ticket;
the searching for the check information associated with the property information from the ticket management server comprises:
searching for the issue number of the ticket recorded in the ticket management server according to the type name of the ticket, and obtaining the check information associated with the issue number of the ticket from the ticket management server.

3. The method of claim 1, wherein the property information further comprises a ticket identification of the ticket, and the check information comprises a winning identification.

4. The method of claim 3, wherein the generating the result matching information of the ticket according to the check information comprises:
matching the ticket identification of the ticket with the winning identification, and generating the result matching information of the ticket according to a matching result, and the result matching information further comprises a winning prompt.

5. The method of claim 1, before searching for the check information associated with the property information from the ticket management server, further comprising:
comparing the real-time current time value with the predetermined drawing time thread value;
upon determining that the real-time current time value exceeds the predetermined drawing time thread value, obtaining the check information associated with the property information; and
upon determining that the real-time current time value does not exceed the predetermined drawing time thread value, obtaining the check information associated with the property information when the predetermined drawing time thread value is up.

6. The method of claim 1, wherein the graphic code is a bar code, a two-dimensional code or a three-dimensional code.

7. An information prompting device for prompting a ticket drawing result, comprising:
a scanning and obtaining module, configured to scan a graphic code of a ticket to obtain property information associated with the graphic code, the property information comprising a predetermined drawing time thread value of the ticket;
an event adding module, configured to add a drawing prompt event corresponding to the predetermined drawing time thread value to a preset event list once a real-time current time value does not exceed the drawing time thread value;
an event triggering module, configured to trigger the drawing prompt event upon a condition that the drawing time thread value is up;
an information obtaining module, configured to, according to triggering of the drawing prompt event, search for check information associated with the property information from a ticket management server; and
a generating and prompting module, configured to generate result matching information of the ticket according to the check information, the result matching information comprising the drawing result; and prompt the result matching information in a sensible form.

8. The device of claim 7, wherein the property information further comprises a type name and an issue number of the ticket;
the information obtaining module is configured to search for the issue number of the ticket recorded in the ticket management server according to the type name of the ticket, and obtain the check information associated with the issue number of the ticket from the ticket management server.

9. The device of claim 7, wherein the property information further comprises a ticket identification of the ticket, and the check information comprises a winning identification.

10. The device of claim 9, wherein the generating and prompting module is configured to match the ticket identification of the ticket with the winning identification, and generate the result matching information of the ticket according to a matching result, and the result matching information further comprises a winning prompt.

11. The device of claim 7, further comprising:
a determining module, configured to compare the real-time current time value with the predetermined drawing time thread value; wherein
the information obtaining module is configured to, when the determining module determines that the real-time current time value exceeds the predetermined drawing time thread value, obtain the check information associated with the property information; and when the determining module determines that the real-time current time value does not exceed the predetermined drawing time thread value, obtain the check information associated with the property information when the predetermined drawing time thread value is up.

12. The device of claim 7, wherein the graphic code is a bar code, a two-dimensional code or a three-dimensional code.

13. A computer readable storage medium, comprising computer program codes for executing processes of:
scanning a graphic code of a ticket to obtain property information associated with the graphic code, the property information comprising a predetermined drawing time thread value of the ticket;
adding a drawing prompt event corresponding to the predetermined drawing time thread value to a preset event list once a real-time current time value does not exceed the drawing time thread value;
upon a condition that the drawing time thread value is up, triggering the drawing prompt event;
according to triggering of the drawing prompt event, searching for check information associated with the property information from a ticket management server;
generating result matching information of the ticket according to the check information, the result matching information comprising the drawing result; and
prompting the result matching information in a sensible form.

14. The computer readable storage medium of claim 13, wherein the property information further comprises a type name and an issue number of the ticket;
the searching for the check information associated with the property information from the ticket management server comprises:
searching for the issue number of the ticket recorded in the ticket management server according to the type name of the ticket, and obtaining the check information associated with the issue number of the ticket from the ticket management server.

15. The computer readable storage medium of claim 13, wherein the property information further comprises a ticket identification of the ticket, and the check information comprises a winning identification.

16. The method of claim 15, wherein the generating the result matching information of the ticket according to the check information comprises:
matching the ticket identification of the ticket with the winning identification, and generating the result matching information of the ticket according to a matching result, and the result matching information further comprises a winning prompt.

17. The computer readable storage medium of claim 13, before searching for the check information associated with the property information from the ticket management server, further comprising:
comparing the real-time current time value with the predetermined drawing time thread value;
upon determining that the real-time current time value exceeds the predetermined drawing time thread value, obtaining the check information associated with the property information; and
upon determining that the real-time current time value does not exceed the predetermined drawing time thread value, obtaining the check information associated with the property information when the predetermined drawing time thread value is up.

18. The computer readable storage medium of claim 13, wherein the graphic code is a bar code, a two-dimensional code or a three-dimensional code.
